(19) United States
(12) Patent Application Publication
(10) Pub. No.: US 2005/0242267 A1
(43) Pub. Date: Nov. 3, 2005

(54) Ground marking device and process and installation comprising same

(75) Inventors: Jean-Louis Lovato, Biviers (FR); Virginie Collomb, Grenoble (FR); Vincent Minier, Claix (FR)

Correspondence Address: STEPTOE & JOHNSON LLP, 1330 CONNECTICUT AVENUE, N.W., WASHINGTON, DC, 20036, US

(73) Assignee: Schneider Electric Industries SAS, Rueil Malmaison (FR)

(21) Appl. No.: 11/092,629

(22) Filed: Mar. 30, 2005

(30) Foreign Application Priority Data
Apr. 28, 2004 (FR) 0404515

(51) Int. Cl. G05D 25/02

(52) U.S. Cl. 250/205; 356/213

(57) ABSTRACT

The marking device comprises a light source and a processing circuit to control lighting of said light source. Said device comprises an optic communication having at least one optic emitter and/or one optic receiver connected to the processing circuit. A detector detects the presence, movement or passage of an object. Said detector is connected to the processing circuit to control the optic communication according to signals supplied by said detector. A marking installation comprises marking devices arranged for example on a section of runway for an airport for guiding aircraft, or on a section of road to perform road signalling. The marking process enables the marking devices to be switched on by optic means according to detections.

### BACKGROUND OF THE INVENTION

The invention relates to a ground marking device comprising a light source and a processing circuit to control lighting of said light source. The invention also relates to a marking process. The invention also relates to a ground marking installation for an airport or aerodrome comprising at least two marking devices arranged on a portion of runway for guiding planes. The invention also relates to a marking installation for a road section comprising at least two marking devices arranged on a portion of road to perform road signalling.

### STATE OF THE ART

Ground marking devices are used in particular to guide aircraft on portions of runways in airports or vehicles on road sections. As represented in the diagram of FIG. 1, state of the art marking devices generally comprise lighting beacons or lamps 1 controlled individually, in a group, simultaneously or sequentially by an electric control circuit 2.

In more complex processes, represented in FIG. 2, the beacons 1 are controlled by means of remote control signal receiver modules 3. In this case, the beacons and modules 3 are connected to the control circuit by a power supply line 4 supplying electric power and by a remote control line 5. The control line can for example be a computer network bus or a home bus. The receiver modules decode the control signals and actuate for example a relay connected to the line 4 to supply the beacons which then switch a light source on. In the example of FIG. 3, the remote control signal receiver modules 3 are connected by radio waves to a remote control device comprising a high-frequency emitter 6. The modules 3 comprise high-frequency receivers receiving radio waves. The line 4 is connected to an electric power supply 7 which is able to be an electric power distribution system.

When existing marking installations operate according to an specifically defined mode that is already wired, changing operating mode often requires reinstallation of all the beacons. For example, it is difficult for beacons installed to be controlled in group mode to be controlled in sequential mode or in individual mode by remote control without modifying the installation. Such modifications do in fact involve adding or installing a remote control bus such as that of FIG. 2.

To palliate the problems of modifying the installation it is possible to use beacons controlled by high frequency waves as in the installation of FIG. 3. However in certain installations in sensitive zones, in particular in airports, remote controls by radio waves are undesirable or prohibited.

Furthermore, state-of-the-art beacons have a passive operation with respect to the objects, the vehicles, or the aircraft for which they have to mark out the path or perform specific signalling.

### SUMMARY OF THE INVENTION

The object of the invention is to provide a ground marking device able to be easily installed or replaced and/or having a dynamic operation, a marking process for marking devices, and an installation comprising at least one such marking device.

A marking device according to the invention comprises:
optic communication means having at least one optic emitter and/or one optic receiver connected to the processing circuit, and
detection means to detect the presence, movement or passage of an object, said detection means being connected to the processing circuit to control the optic communication means according to signals supplied by said detection means.

Preferably, the communication means comprise an optic receiver to receive a lighting control signal emitted by another marking device.

Preferably, the detection means comprise a photo-detector or a receiver diode to detect a light signal reflecting a light emitted by the light source.

Advantageously, the optic communication means comprise optic receivers and filtering means and/or encoding means to filter and/or encode optic communication signals.

In a preferred embodiment, the light source comprises light-emitting diodes for lighting the marking device, the detection means detecting a signal reflecting a light emitted by the light-emitting diodes, the processing circuit performing encoding of the light source and/or recognition of signals representative of light signals received by the detection means.

For example, the light source comprises light-emitting diodes emitting in a first color and light-emitting diodes emitting in a second color to modify the color of the light of said light source.

In a particular embodiment, the device comprises light-emitting diodes connected to modulating means to emit optic communication signals to other marking devices, said light-emitting diodes emitting marking light as light source and optic communication signals.

Advantageously, the processing circuit comprises means for evaluating the speed of an object between two marking devices.

Advantageously, the processing circuit comprises means for evaluating the distance between two objects detected by marking devices.

Advantageously, the processing circuit processes information from the detection means and centralizes information received by the optic communication means.

Preferably, the processing circuit processes information from the detection means and controls the communication means to emit optic control signals to command switch-on of at least one other marking device when there is a detection.

Advantageously, the processing circuit comprises transfer means to receive first optic communication signals from a first other marking device and send information contained in the signals received to a second other marking device by means of an optic communication.

Preferably, the processing circuit processes information from signals received by the optic communication means and commands switch-on of lighting of the light source if said signals contain light source control information.

Preferably, the processing circuit commands switch-off of lighting of the light source after the end of detection by the detection means.

In particular embodiments, the marking device comprises an autonomous power source, means for controlling an actuator and/or at least one environment sensor.

According to another embodiment of the invention, a marking installation for an airport or aerodrome, comprising at least two ground marking devices arranged on a portion of runway for guiding planes, comprises marking devices as defined above communicating by optic means, the detection means of said marking devices being able to detect aircraft.

In a preferred embodiment, at least one marking device detecting the presence of an aircraft emits optic control signals to at least one following marking device to command switch-on of the light source of at least one following marking device.

According to an embodiment of the invention, a marking installation for a road section, comprising at least two marking devices arranged on a portion of road to perform road signalling, comprises marking devices as defined above communicating by optic means, the detection means of said marking devices being able to detect road-going vehicles.

In a preferred embodiment, at least one marking device detecting the presence or passage of a vehicle emits optic control signals to at least one following marking device to command switch-on of the light source of at least one following marking device.

Advantageously, at least one marking device comprises a processing circuit with means for evaluating the speed of a vehicle between two marking devices and provides excessive speed detection signals if an evaluated speed value exceeds a preset speed limit value.

Advantageously, at least one marking device comprises a processing circuit with means for evaluating the distance between two vehicles according to signals provided by its detection means and/or according to detection signals provided by other marking devices and provides distance overshoot signals if an evaluated distance value exceeds a preset limit distance value.

Preferably, at least one marking device comprises means for controlling the light source for specific lighting when said marking device detects or receives signals representative of excessive speed or limit distance overshoot.

Preferably, at least marking device receives, emits and uses safety signals in its processing circuit, said safety signals being able to trigger control of the light source for specific lighting.

A marking process according to the invention comprises:
a switch-on step of a light source commanded by receipt of a control light signal emitted by a previous marking device,
a detection step to detect the passage or presence of an object intended to be detected,
a communication step of a detection light signal or of a switch-on command to at least one following marking device, and
a step commanding end of lighting of said light source when detection is terminated.

### BRIEF DESCRIPTION OF THE DRAWINGS

Other advantages and features will become more clearly apparent from the following description of particular embodiments of the invention, given as non-restrictive examples only, and represented in the accompanying drawings in which:

FIGS. 1, 2 and 3 represent diagrams of installations of ground marking devices of the prior art,

FIG. 4 represents a ground marking device according to a first embodiment of the invention,

FIG. 5 represents a diagram of a ground marking device according to a second embodiment of the invention,

FIG. 6 represents a diagram of a ground marking device according to a third embodiment of the invention,

FIG. 7 represents a diagram of a ground marking device according to a fourth embodiment of the invention,

FIG. 8 represents an installation of a section of airport runway with devices according to the invention,

FIGS. 9, 10 and 11 represent optic communications between ground marking devices according to embodiments of the invention;

FIG. 12 represents an installation of a road section with devices according to the invention,

FIG. 13 represents a diagram of a ground marking device according to an embodiment of the invention adapted for marking a road section,

FIG. 14 represents a flowchart of a marking process according to an embodiment of the invention.

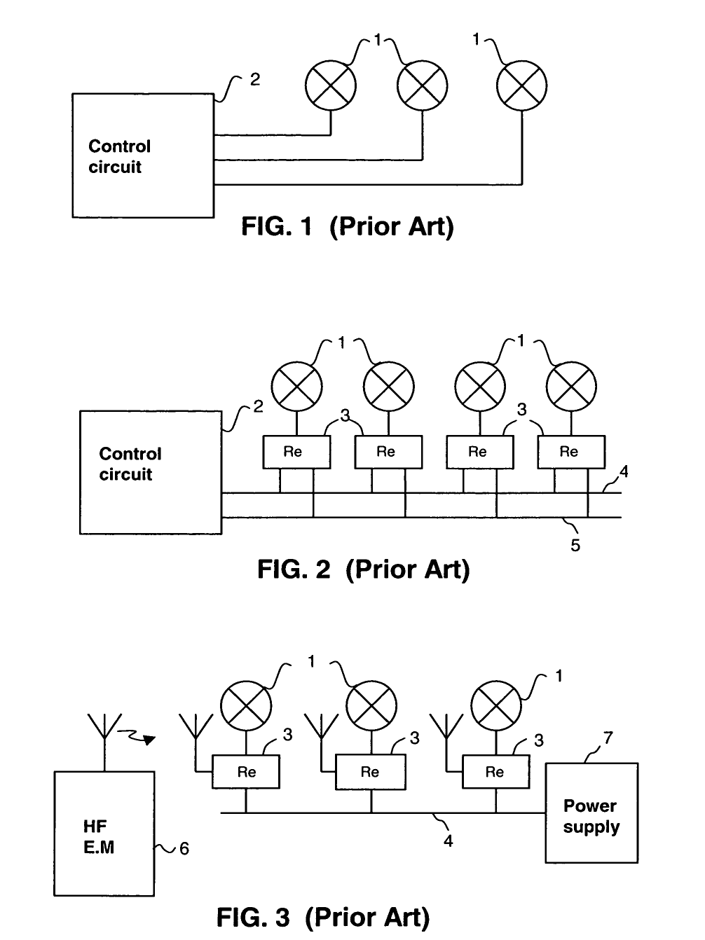

### DETAILED DESCRIPTION OF PREFERRED EMBODIMENTS

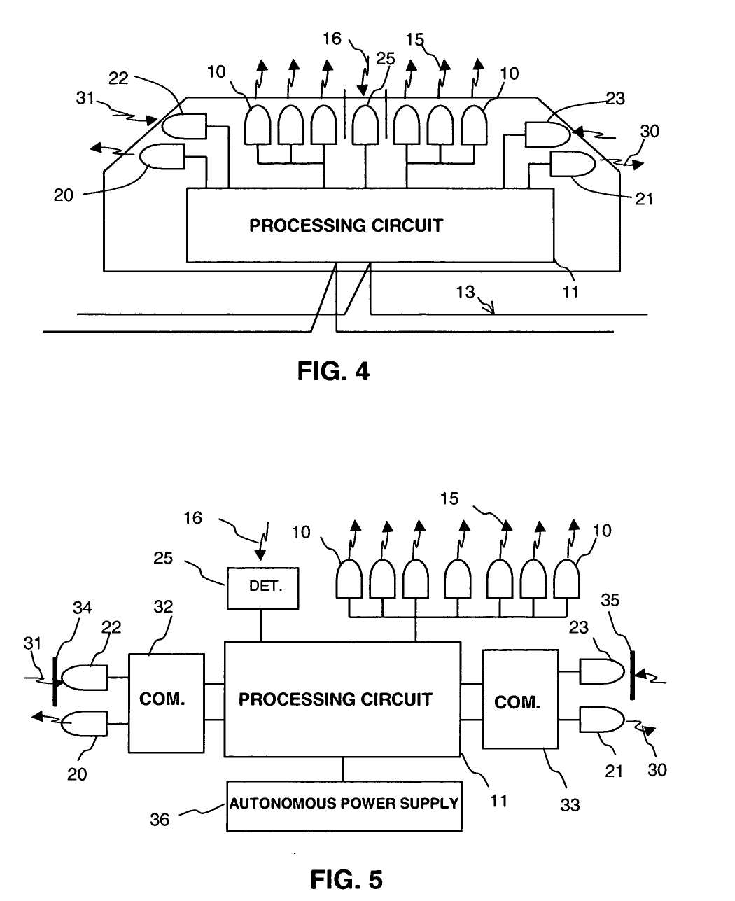

A ground marking device represented in FIG. 4 comprises a light source 10 controlled by a processing circuit 11. To control lighting of said light source, the processing circuit receives electric power supplied by a power supply line 13. According to an embodiment of the invention, the marking device comprises communication means and detection means connected to the processing circuit.

The communication means are represented by emitters such as light-emitting diodes 20 and 21 and receivers such as receiver diodes 22 and 23 connected to the processing circuit 11. The receiver diode 22 can receive a switch-on control signal of the light source supplied by another marking device. For example, a lighting control signal can be emitted by a previous marking device in an installation scheduled for sequential lighting of the marking devices.

The detection means enable the presence, movement or passage of an object to be detected. They are represented by an optic detector such as a diode 25, or a photo-detector, connected to the processing circuit to supply a detection signal to the processing circuit. Thus, the processing circuit 11 controls the optic communication means, in particular an emitter 21, according to a signal supplied by said optic detector 25. The detector 25 detects a light 16 corresponding to reflection of a light 15 emitted by the light source 10 on an object such as an aircraft or a vehicle.

The devices according to embodiments of the invention communicate with one another by optic signals. Thus, when a first marking device detects passage of an object by light reflection, the optic communication means, in particular the emitter 21, are controlled to emit an optic signal 30 to a second marking device to command lighting of the light source 10. The device can also receive an optic control signal on its receiver 22 to receive an optic control signal 31 designed to command lighting of the light source 10. In a particular embodiment with one-way communication, the marking device can comprise a single receiver 22 and a single emitter 21 for sequential lighting. In other marking devices according to other embodiments, the communications between devices can be performed in two-way manner.

Such marking devices can easily replace previous beacon markers without requiring additional control wire or bus installations between the beacons. In addition, its marking devices do not have a radio system disturbing the electromagnetic environment.

In the diagram of FIG. 5, the communication means also comprise encoding and/or decoding modules 32 and 33 to encode or decode the signals received or emitted by the optic receivers 22, 23 or the optic emitters 20 and 21. To improve communication and ensure correct operation of receipt of the optic communication signals, optic filters 34 and 35 are arranged in front of the optic receivers respectively 22 and 23. For example, infrared filters 34 and 35 enable a good infrared communication avoiding saturation of the receivers. The modules 32 and 33 enable reliable communication since encoding of the information enables the emitting and/or receiving marking devices to be recognized.

The device of FIG. 5 can comprise an autonomous power source for example batteries or solar energy cells. Thus, for certain applications, connections to an electric mains power supply are no longer necessary, the communication or remote control links being performed by optic means.

Advantageously, the light source 10 comprises light-emitting diodes for lighting of the marking device. Control of the source can also be encoded by the processing circuit 11 to be recognized when detection takes place. Such encoding enables the lightings produced by other light sources to be rejected when detection takes place. In this case, the detectors receive signals when reflection of a light emitted by the light-emitting diodes takes place, then the processing circuit recognizes the encoded signals to trigger a detection.

In embodiments of the invention, the processing circuit processes information representative of detection and information received by at least one optic communication receiver. When a detection has been made, it also commands at least one communication emitter to emit optic control signals to switch on at least one other marking device. The processing circuit processes information of the signals received by at least one optic receiver and commands switch-on of the light source if said signals comprise control information of the light source. As soon as a detection is terminated, the processing circuit commands switch-off of the light source lighting. The switch-off command of the light source lighting can be performed immediately or after a preset time delay.

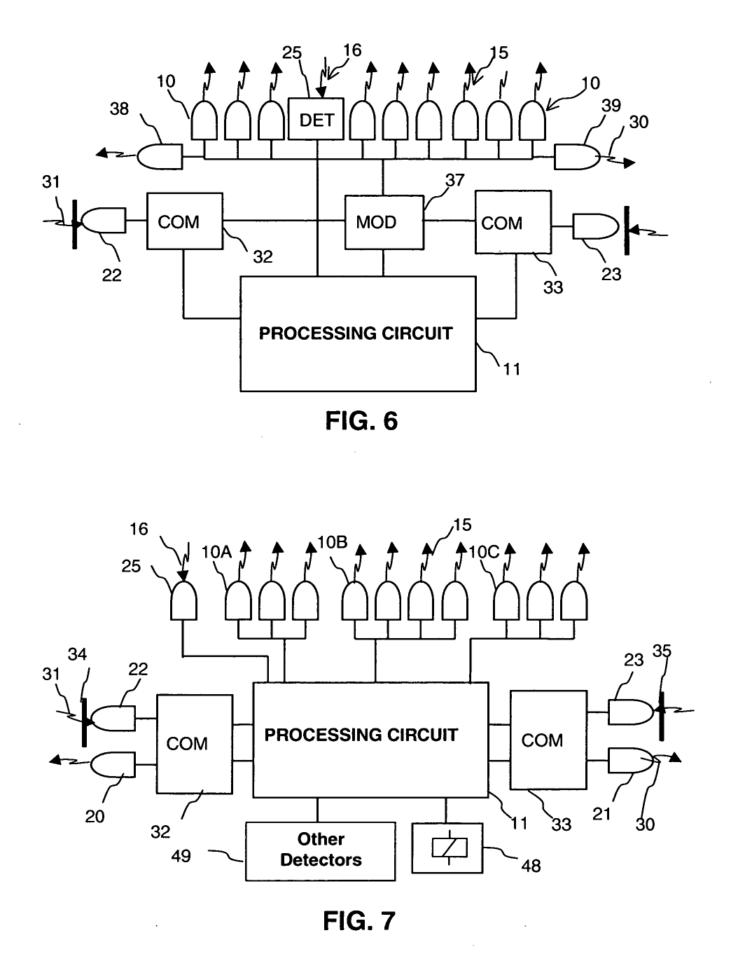

In an embodiment represented in FIG. 6, the marking device emits control signals to another device with the light from the light source. In this case, a modulating circuit 37 modulates control of the light-emitting diodes of the light source according to control signals to be sent to another device. The light source can have diodes 38 and/or 39 directed towards other devices. The diodes 38 and 39 can also have different colors or wavelengths from the other diodes 10 of the light source. The processing circuit 11 can encode in a different manner the light 15 from the light source 10 for detection, or to communicate with a first device and/or with another second device.

In an embodiment represented in FIG. 7, the marking device can emit a light source of different colors for different signallings. For example, the light source 10 can comprise first diodes 10A lighting in a first color, second diodes 10B lighting in a second color and possibly third diodes 10C lighting in a third color. The color of the light source can also be achieved by a combination of the light colors of different diodes.

In the diagram of FIG. 7, the marking device can also comprise control means of an actuator 48. This actuator can for example be a relay, a mechanical indicator or an electrical barrier. The marking device can also comprise at least one environment sensor 49. The environment sensor can in particular be a temperature sensor, a brightness sensor, a pressure sensor or a humidity sensor.

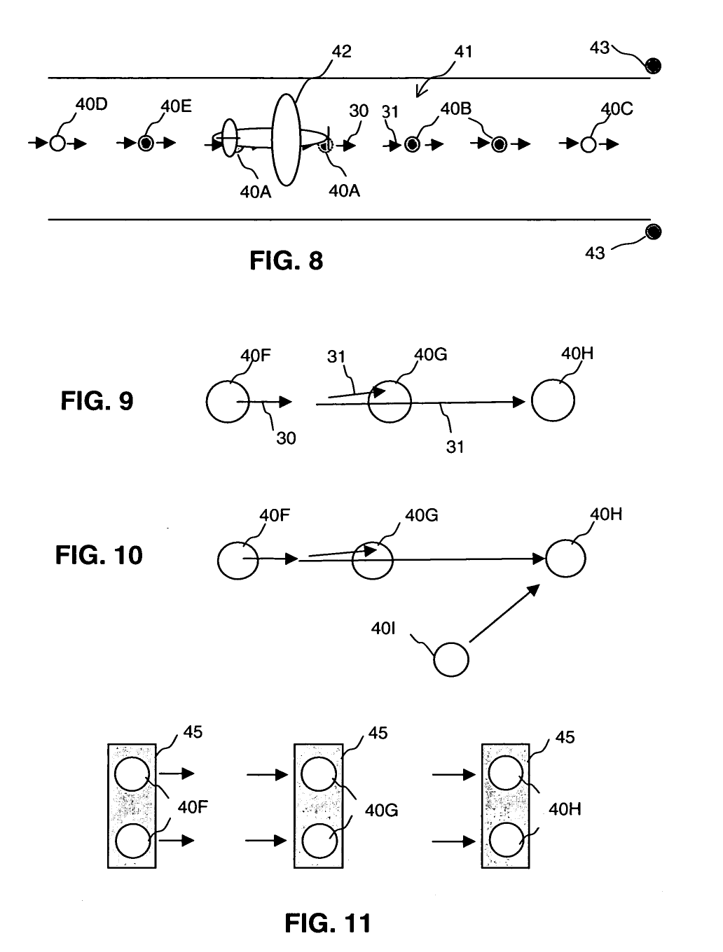

FIG. 8 represents a ground marking installation for an airport or aerodrome comprising marking devices 40A to 40E arranged over a section 41 of runway for guiding aircraft 42. Devices are as defined above with communications by optic means. In this embodiment, the detectors are able to detect aircraft. Thus, a marking device detecting the presence of an aircraft emits optic control signals 30 to at least one following marking device to command switch-on of the light source of at least one following marking device. The signal 30 emitted by a device corresponds to a signal 31 received by another device.

In the installation represented in FIG. 8, marking devices 40A are detecting the passage or presence of an aircraft, and emit to following marking devices 40B optic lighting signals 30 of the light source. The following marking devices 40B light the path of the runway to guide the aircraft 42 but the device 40C located farthest away does not receive any switch-on signals 31 concerning it, and its light source 10 remains off. After the aircraft has passed, a marking device 40D has switched its light source 10 off and a marking device 40E is waiting for its light source 10 to be switched off after a preset time delay. End of runway marking devices 43 can light with a light source 10 of a different color, for example red, to indicate stopping of the aircraft 42.

FIGS. 9, 10 and 11 show the incidences and communications of different marking devices installed in fairly close locations. In FIG. 9, a first marking device 40F emits optic control signals to a second marking device 40G and a third marking device 40H. If the devices 40G and 40H are aligned, a single optic communication beam can be sufficient. Advantageously, the optic communication signals are encoded to be recognized by the processing circuits of the marking devices. Thus in the example of FIG. 10, the marking device recognizes and accepts the commands coming from the marking devices 40F and 40G but rejects the commands coming from another device 401 which is not part of the same marking group. In FIG. 11, marking devices are installed in redundancy groups 45 to improve the reliability of detection and transmission of optic control signals.

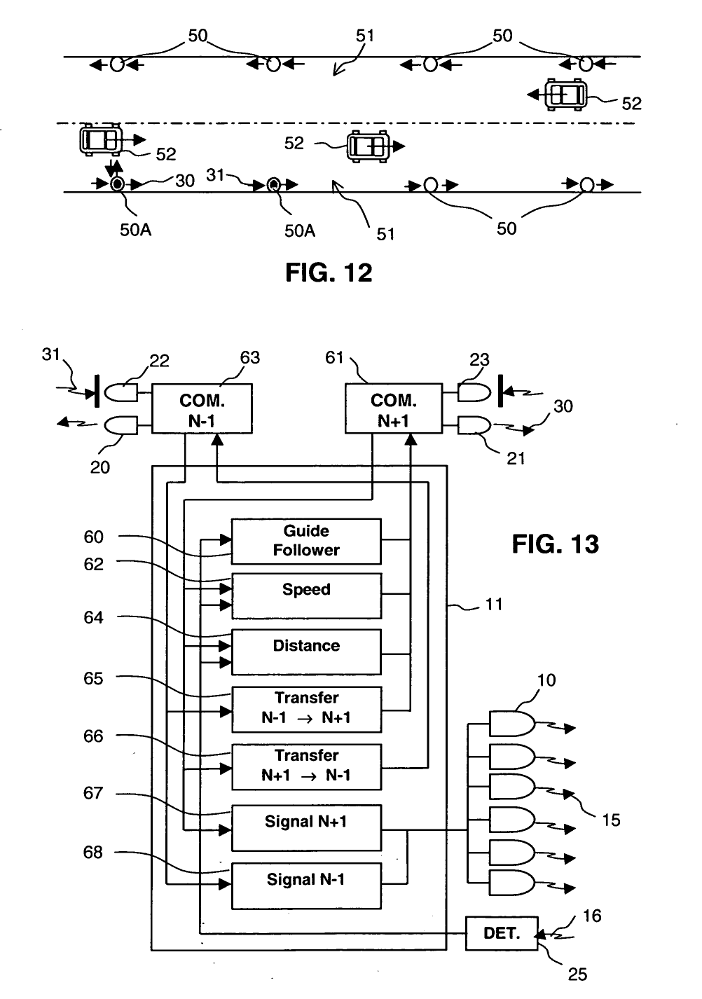

FIG. 12 represents a marking installation for a road section comprising marking devices 50, 50A, SOB arranged over a portion 51 of road to perform road signalling. Devices are as defined above with communications by optic means. In this embodiment, the detectors are able to detect road-going vehicles 52. Thus, a marking device 50A detecting the presence of a vehicle 52 emits optic control signals to at least one following marking device 50B to command switch-on of the light source of at least one following marking device 50B.

A marking device according to one embodiment notably adapted for an installation for a road section is represented in FIG. 13. The processing circuit 11 comprises a guide follower module 60 to successively switch on marking devices according to the movement of a vehicle. The module 60 receives a detection signal from the detector 25 and sends a control signal to a following device or N+1 via the communication and encoding and/or decoding circuit 61 and the optic emitter 21.

The processing circuit 11 advantageously comprises a speed evaluation module 62 of a vehicle between two marking devices and supplies excessive speed detection signals if an evaluated speed value exceeds a preset speed limit value. The module 62 receives a detection signal from the detector 25 and a control or passage signal from a previous marking device or N−1 via a communication and encoding and/or decoding circuit 63 and the optic receiver 22. Then it determines the speed of the vehicle and sends a control signal to a following marking device. The processing circuit 11 can also comprise an evaluation module 64 of the distance between two vehicles according to detection signals supplied by its detection means and/or according to detection signals supplied by other marking devices and supplies distance overshoot signals if an evaluated distance value exceeds a preset limit distance value.

In the embodiment of FIG. 13, the processing circuit comprises a module 65 to transfer by optic means command signals coming from a previous device N−1 to a following device N+1, and a module 66 to transfer by optic means command signals coming from a following device N+1 to a previous device N−1. Such transfers can also serve the purpose of monitoring the whole chain of marking devices.

The processing circuit can command the light source when the modules of the marking device detect or receive signals representative of speed or distance limit overshoot. A marking device can receive, emit or use safety signals in its processing circuit. A safety lighting can be a lighting flashing at a particular frequency or lighting with a different color.

To command normal lighting or safety lighting the processing circuit comprises modules 67 and 68 to receive optic signals from a previous marking device N−1 or from a following marking device N+1.

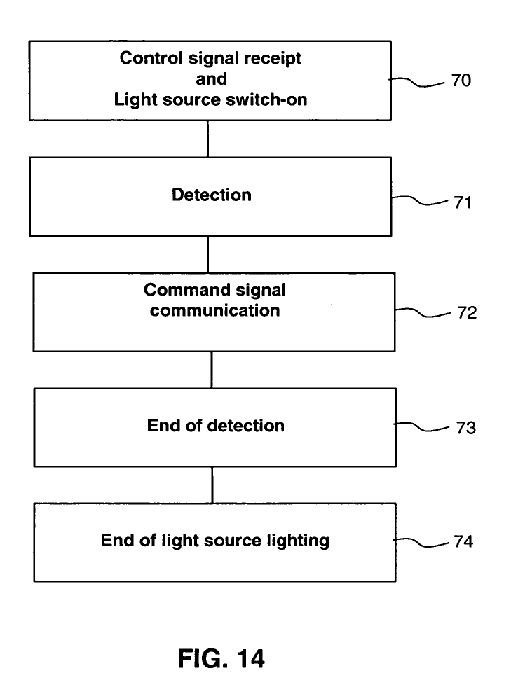

FIG. 14 shows an embodiment of a flowchart of a marking process. In a step 70, switch-on of a light source is commanded by receipt of a control light signal emitted by a previous marking device. Then in a detection step 71, detection of passage or presence of an object designed to be detected is scheduled, for example an aircraft or a vehicle. Following detection, a communication step 72 enables a detection or switch-on command light signal to be sent to at least one following marking device. In a step 73, end of a detection indicates the end of a passage or of a presence. Then in a step 74, when detection is terminated, command of end of lighting of said light source is performed.

In marking devices according to embodiments of the invention, the light source and optic communication signals can be of the same wavelengths or color. However, they can also be of different wavelengths, for example white, red, green, yellow or blue, for the light source and infrared for the optic or light communication signals.

The devices described above can also have as a supplement hardwired or carrier current communication means to operate for example in redundancy with optic communication means. For example, when marking devices comprise autonomous power supply sources such as batteries, the devices can operate in optic and hardwired communication in normal operation and in optic and autonomous operation if the electric current supply is interrupted.

Marking devices can communicate between one another by optic means, a grouping of information being able to be performed on a marking device which receives commands and/or sends information back to a central unit. The link to a central unit can be achieved by optic means or by hardwired means.

1. Marking device comprising a light source and a processing circuit to control lighting of said light source, and comprising:
optic communication means having at least one optic emitter connected to the processing circuit, and
detection means to detect the presence, movement or passage of an object, said detection device being connected to the processing circuit to control the optic communication means according to signals supplied by said detection means,
said at least one optic emitter emitting an optic communication signals of lighting command to at least one other marking device when a detection signal is supplied to said processing circuit.

2. Marking device according to claim 1 wherein the communication means comprise an optic receiver to receive a lighting command signal emitted by another marking device.

3. Marking device according to claim 1 wherein the detection means comprise a photo-detector or a receiver diode to detect a light signal reflecting a light emitted by the light source.

4. Marking device according to claim 1 wherein the optic communication means comprise optic receivers and filtering means and/or encoding means to filter and/or encode optic communication signals.

5. Marking device according to claim 1 wherein the light source comprises light-emitting diodes for lighting the marking device, the detection means detecting a signal reflecting a light emitted by the light-emitting diodes, the processing circuit performing encoding of the light source and/or recognition of signals representative of light signals received by the detection means.

6. Marking device according to claim 1 wherein the light source comprises light-emitting diodes emitting in a first color and light-emitting diodes emitting in a second color to modify the color of the light of said light source.

7. Marking device according to claim 1 comprising light-emitting diodes connected to modulating means to emit optic communication signals to other marking devices, said light-emitting diodes emitting marking light as light source and optic communication signals.

8. Marking device according to claim 1 wherein the processing circuit comprises means for evaluating the speed of an object between two marking devices.

9. Marking device according to claim 1 wherein the processing circuit comprises means for evaluating the distance between two objects detected by marking devices.

10. Marking device according to claim 1 wherein the processing circuit processes information from the detection means and centralizes information received by the optic communication means.

11. Marking device according to claim 1 wherein the processing circuit processes information from the detection means and controls the communication means to emit optic control signals to switch on at least one other marking device when there is a detection.

12. Marking device according to claim 1 wherein the processing circuit comprises transfer means to receive first optic communication signals from a first other marking device and to send information contained in the signals received to a second other marking device by an optic communication.

13. Marking device according to claim 1 wherein the processing circuit processes information from signals received by the optic communication means and commands switch-on of the light source if said signals comprise control information of the light source.

14. Marking device according to claim 1 wherein the processing circuit commands switch-off of the light source after the end of detection by the detection means.

15. Marking device according to claim 1 comprising an autonomous power source.

16. Marking device according to claim 1 comprising means for controlling an actuator.

17. Marking device according to claim 1 comprising at least one environment sensor.

18. Ground marking installation for an airport or aerodrome comprising at least two marking devices arranged on a section of runway for guiding aircraft comprising marking devices according to claim 1 communicating by optic means, the detection means of said marking devices being able to detect aircraft.

19. Marking installation according to claim 18 wherein at least one marking device detecting the presence of an aircraft emits optic control signals to at least one following marking device to command switch-on of the light source of at least one following marking device.

20. Marking installation for a road section comprising at least two marking devices arranged on a section of road to perform road signalling comprising marking devices according to claim 1 communicating by optic means, the detection means of said marking devices being able to detect road-going vehicles.

21. Marking installation according to claim 20 wherein at least one marking device detecting the presence or passage of a vehicle emits optic control signals to at least one following marking device to command switch-on of the light source of at least one following marking device.

22. Marking installation claim 20 wherein at least one marking device comprises a processing circuit with means for evaluating the speed of a vehicle between two marking devices and supplies excessive speed detection signals if an evaluated speed value exceeds a preset speed limit value.

23. Marking installation according to claim 20 wherein at least one marking device comprises a processing circuit with means for evaluating the distance between two vehicles according to detection signals supplied by its detection means and/or according to detection signals supplied by other marking devices and supplies distance overshoot signals if an evaluated distance value exceeds a preset limit distance value.

24. Marking installation according to claim 22 wherein at least one marking device comprises control means of the light source for specific lighting when said marking device detects or receives signals representative of excessive speed or limit distance overshoot.

25. Marking installation according to claim 20 wherein at least one marking device receives, emits and uses safety signals in its processing circuit, said safety signals being able to trigger control of the light source for specific lighting.

26. Marking process comprising:
a switch-on step of a light source commanded by receipt of a control light signal emitted by a previous marking device,
a detection step to detect the passage or presence of an object intended to be detected,
a communication step of a detection light signal or of a switch-on command to at least one following marking device, and
a step commanding end of lighting of said light source when detection is terminated.
